(19) United States
(12) Patent Application Publication
(10) Pub. No.: US 2023/0128204 A1
(43) Pub. Date: Apr. 27, 2023

(54) METHOD AND DEVICE FOR PRODUCING SPUNBONDED FABRIC

(71) Applicant: LENZING AKTIENGESELLSCHAFT, 4860 Lenzing (AT)

(72) Inventors: Ibrahim Sagerer-Foric, 4840 Vöcklabruck (AT); Rudolf Kern, 4840 Vöcklabruck (AT); Alexander Teubl, 4851 Gampern (AT); Wolfgang Engl, 4802 Ebensee (AT)

(21) Appl. No.: 17/801,603

(22) PCT Filed: Feb. 24, 2021
(86) PCT No.: PCT/EP2021/054496

§ 371 Date: Aug. 23, 2022

(30) Foreign Application Priority Data
Feb. 24, 2020 (EP) 20159097.3

(51) Int. Cl. D04H 3/16; D04H 3/02; D04H 3/11; D04H 3/013

(52) U.S. Cl. CPC D04H 3/16; D04H 3/02; D04H 3/11; D04H 3/013

(57) ABSTRACT

A process for the production of spunbonded nonwoven (1) and a device for this purpose are shown, wherein a spinning mass (2) containing solvent is extruded through a plurality of nozzle holes of at least one spinneret (3) to form filaments (4) and the filaments (4) are drawn, in each case, in the extrusion direction, wherein the filaments (4) are deposited on a perforated conveying device (9) to form a spunbonded nonwoven (1) and, subsequently, are subjected to washing (10) for washing out the solvent from the filaments (4) and to hydroentanglement (11). So as to allow an inexpensive and efficient production of hydroentangled spunbonded nonwoven by means of the process, it is suggested that fresh water (12) is supplied to the hydroentanglement (11) and the waste water (13) from the hydroentanglement (11) is supplied to the washing (10) as wash water (14).

### BACKGROUND OF THE INVENTION

### Field of the Invention

The present invention relates to a process for the production of spunbonded nonwoven, wherein a spinning mass containing solvent is extruded through a plurality of nozzle holes of at least one spinneret to form filaments and the filaments are drawn, in each case, in the extrusion direction, wherein the filaments are deposited on a perforated conveying device to form a spunbonded nonwoven and, subsequently, are subjected to washing for washing out the solvent from the filaments and to hydroentanglement.

Furthermore, the invention relates to a device for the production of spunbonded nonwoven, comprising at least one spinneret for extruding a spinning mass into filaments, comprising a drawing device for drawing the extruded filaments by means of a drawing air stream, the drawing device being allocated to the spinneret, comprising a perforated conveying device for depositing the filaments and forming the spunbonded nonwoven, comprising a washing for washing the spunbonded nonwoven after it has been formed and comprising a hydroentanglement downstream of the washing.

### Prior Art

The production of spunbonded nonwovens and, respectively, nonwoven fabrics by the spunbond process, on the one hand, and by the meltblown process, on the other hand, is known from the prior art. In the spunbond process (e.g., GB 2 114 052 A or EP 3 088 585 A1), the filaments are extruded through a nozzle and pulled off and drawn by a drawing unit located underneath. By contrast, in the meltblown process (e.g., U.S. Pat. Nos. 5,080,569 A, 4,380,570 A or 5,695,377 A), the extruded filaments are entrained and drawn by hot, fast process air as soon as they exit the nozzle. In both technologies, the filaments are deposited in a random orientation on a deposit surface, for example, a perforated conveyor belt, to form a nonwoven fabric, are carried to post-processing steps and finally wound up as nonwoven rolls.

It is also known from the prior art to produce cellulosic spunbonded nonwovens according to the spunbond technology (e.g., U.S. Pat. No. 8,366,988 A) and according to the meltblown technology (e.g., U.S. Pat. Nos. 6,358,461 A and 6,306,334 A). A lyocell spinning mass is thereby extruded and drawn in accordance with the known spundbond or meltblown processes, however, prior to the deposition into a nonwoven, the filaments are additionally brought into contact with a coagulant in order to regenerate the cellulose and produce dimensionally stable filaments. The wet filaments are finally deposited in a random orientation as a nonwoven fabric.

While, in thermoplastic spunbond processes, calenders are usually used for fusing several layers of spunbonded nonwoven together, in the production of cellulosic spunbonded nonwoven, as it is known from U.S. Pat. No. 8,282,877 B2, a hydroentanglement plant may be used for connecting several layers of nonwoven fabric.

Furthermore, it is known from the prior art (EP 2 041 344 B1 and U.S. Pat. No. 9,394,637) to use hydroentanglement plants for the solidification, perforation and embossing of nonwoven fabrics in particular so as to influence their strength, appearance and feel.

A drawback associated with hydroentanglement consists in the great expenditure on equipment and maintenance for cleaning the water circuit, the filters and the nozzle bars, as illustrated in EP 2 462 269 B1. For example, such systems specifically involve high filtration costs. In some cases, single-use bag filters, which have to be disposed of, are used for this. It is likewise a disadvantage of such systems that they have a high water consumption, with drinking water usually being used for the hydroentanglement and part of it being continuously disposed of as waste water in the sewer in order to keep the water quality constant in the circuit.

In the case of the production of cellulosic spunbonded nonwoven, the hydroentanglement, as known, for example, from WO 2018 071928 A1, takes place subsequent to the washing. Especially when the washing system is being started up and shut down, or, respectively, in the event of disruptions in the process sequence, it may happen in such processes that, during operation, solvent gets with the nonwoven fabric into the water circuit of the hydroentanglement and is thus lost.

Since the cellulosic spunbonded nonwovens have very fine filament diameters, very fine fragments are formed during the hydroentanglement and, as a result, the filters are covered quickly and have to be replaced constantly.

The prior art fails to offer a satisfactory solution for the hydroentanglement of cellulosic spunbonded nonwoven, since the expenditure for the filtration, the replacement of filters and nozzle strips, but also the loss in solvent, are too high.

### SUMMARY OF THE INVENTION

Therefore, it is the object of the present invention to provide a process for the production of spunbonded nonwoven of the initially mentioned type, which enables an inexpensive and efficient production of hydroentangled spunbonded nonwoven.

The invention achieves the object that is posed in that fresh water is supplied to the hydroentanglement and the waste water from the hydroentanglement is supplied to the washing as wash water.

If fresh water is supplied to the hydroentanglement and the waste water from the hydroentanglement is supplied to the washing as wash water, the expenditure on maintenance and cleaning of the hydroentanglement can be kept low.

By supplying fresh water to the hydroentanglement, contaminations due to solid components, such as fibres, can be avoided in comparison to circulating the water during the hydroentanglement, thus minimizing the expenses for the filtration of the hydroentanglement, the expenses for cleaning the nozzles thereof, but also the loss in solvent.

Moreover, by supplying the waste water from the hydroentanglement as wash water further to the washing, the water consumption and the waste water load caused by the hydroentanglement can be reduced. Since the hydroentanglement occurs downstream of the washing, the waste water from the hydroentanglement also exhibits only minimal amounts of solvent and thus essentially does not impair the washing performance of the washing.

In connection with the present invention, fresh water is understood to be a water that is essentially free from impurities due to, for example, solids, solvents, etc. In this case, the fresh water may be, for example, treated process water or conventional unconsumed fresh water.

The process according to the invention in particular allows the cleaning costs associated with the nozzle strips of the hydroentanglement to be minimized and, hence, enables an increase in productivity, since downtimes during maintenance may be reduced. In addition, a smaller amount of waste might accumulate in the process, since bag filtration can be omitted and chemicals as filtration aids are not required, either. Without filtration, the operational effort for the operating personnel and the complexity of the process can be reduced substantially. According to the invention, both the amount of waste water and the loss in solvent are reduced, since the demineralized fresh water first enters the hydroentanglement and, subsequently, is used as wash water for the countercurrent washing.

According to the invention, it has moreover been shown that the amount of wash water required for operating a large-scale washing system, in particular for the production of cellulosic spunbonded nonwoven, and the amount of fresh water required for operating the hydroentanglement are approximately the same. It has been shown that it is possible to supply the hydroentanglement with demineralized fresh water and to use the waste water from the hydroentanglement subsequently as wash water for the countercurrent washing system without the need to add additional wash water.

If demineralized water (DI water) is used as fresh water, it is possible, for example, to reliably prevent algae growth or other biological deposits in plant components. In addition, the cellulosic spunbonded nonwoven produced by the process according to the invention may exhibit very low calcium and magnesium concentrations when DI water is used for the hydroentanglement (instead of tap or drinking water), whereby the reliability of the process can be increased further.

If the washing is furthermore a multi-stage countercurrent washing and the waste water from the hydroentanglement is passed in countercurrent as wash water through the washing stages of the countercurrent washing, a particularly resource-efficient and cost-effective process can be created, since a single supply of fresh water to the hydroentanglement is sufficient for the entire process chain from the washing up to and including the hydroentanglement, while all downstream washing stages are fed with the waste water from the previous stage or, respectively, the hydroentanglement.

Furthermore, in this connection, it is particularly advantageous if the hydroentanglement is designed concurrently as the final washing stage in the countercurrent washing. In this way, a process can be created that is feasible in an inexpensive and, at the same time, technically simple manner, since washing and hydroentanglement do not have to be implemented as separate units.

The reliability of the washing can be improved further if the waste water from the hydroentanglement is degassed and the degassed waste water from the hydroentanglement is supplied to the washing as wash water. In doing so, the air introduced into the water during the hydroentanglement can, in fact, be reliably removed from the waste water, and the efficiency of the washing can thus be improved.

If the solvent-enriched waste water from the washing is supplied to a water treatment system, the environmental compatibility of the process can be improved further, since the used fresh water can be separated from the solvents in a water treatment system and can be treated.

Furthermore, in this case, the cost efficiency of the process can be improved further if solvents are recovered from the waste water in the water treatment system. A loss in solvent via the waste water from the washing can thus be prevented, and the recovered solvent can be reused, for example, for the dissolution of cellulose.

A further increase in cost efficiency can be achieved if water purified in the water treatment system is recovered from the waste water. The purified water thus obtained can then be supplied at least partially to the hydroentanglement as fresh water, whereby a cycle between the supply of fresh water for the hydroentanglement and the discharge of waste water from the washing can be created. Particularly preferably, the purified water recovered from the water treatment system may, in this case, be a demineralized water.

A technically simple and reliable process can be created if the spunbonded nonwoven is subjected to hydroentanglement on a second conveying device. For this purpose, the spunbonded nonwoven can be deposited on the second conveying device after it has been formed on the perforated first conveying device. In doing so, the spunbonded nonwoven can preferably be subjected to the washing also on the second conveying device, namely before the spunbonded nonwoven is supplied to the hydroentanglement.

If the second conveying device exhibits an embossing structure with an embossing pattern and the spunbonded nonwoven is provided with the embossing pattern by the hydroentanglement on the second conveying device, a technically simple process can be created which simultaneously allows the spunbonded nonwoven to be solidified and perforations and embossing patterns to be introduced in the course of the hydroentanglement. In this way, spunbonded nonwovens can be produced for a variety of scopes of application, using the process according to the invention.

In addition, by means of the process according to the invention, a multi-layered spunbonded nonwoven with an embossing structure can be created, if the spinning mass is extruded into filaments through a plurality of nozzle holes of several spinnerets arranged one behind the other. In doing so, the filaments are drawn, in each case, in the extrusion direction by a drawing air stream, and, finally, the respective filaments of the multiple spinnerets are deposited on top of each other on the conveying device to form the multi-layered spunbonded nonwoven. In this way, the throughput of the process can be increased, since several spunbonded nonwovens can be formed simultaneously from several spinnerets. However, the multi-layered spunbonded nonwoven thus formed can be processed further jointly with the available means without the need for a separate processing of the individual spunbonded nonwovens. In addition, the multi-layered spunbonded nonwoven can be formed from individual spunbonded nonwoven layers with different properties, whereby a very versatile spunbonded nonwoven can be created. For example, the individual spunbonded nonwovens may have different basis weights, different air permeabilities, different filament diameters, etc. By means of the process according to the invention, the multi-layered spunbonded nonwoven can then be solidified during the hydroentanglement, or can also be perforated or provided with an embossing pattern.

The pressure for the fresh water in the hydroentanglement may be between 0 bar and 500 bar, preferably between 10 bar and 250 bar, particularly preferably between 20 bar and 200 bar.

The volume flow of fresh water in the hydroentanglement may be between 0.1 m³/h and 500 m³/h, preferably between 10 m³/h and 250 m³/h, particularly preferably between 20 m³/h and 150 m³/h.

The process according to the invention may excel especially in the production of cellulosic spunbonded nonwovens, the spinning mass being a lyocell spinning mass, i.e., a solution of cellulose in a direct solvent for cellulose.

Such a direct solvent for cellulose is a solvent in which the cellulose is present in a dissolved state in a non-derivatized form. This can preferably be a mixture of a tertiary amine oxide, such as NMMO (N-methylmorpholine-N-oxide), and water. Alternatively, certain ionic liquids or mixtures thereof with water are, for example, also suitable as direct solvents.

In this case, the content of cellulose in the spinning mass may range from 3% by weight to 17% by weight, in preferred embodiment variants from 5% by weight to 15% by weight, and in particularly preferred embodiment variants, from 6% by weight to 14% by weight.

The throughput of cellulose per spunbonded nonwoven nozzle may range from 5 kg/h per m of nozzle length to 500 kg/h per m of nozzle length.

In addition, the internal structure of the spunbonded nonwoven can be reliably controlled if the filaments that have been extruded from the spinneret and drawn are partially coagulated.

For this purpose, a coagulation air stream comprising a coagulation liquid can be allocated to the spinneret for an at least partial coagulation of the filaments, whereby the internal structure of the spunbonded nonwoven can be controlled specifically. In this case, a coagulation air stream can preferably be a fluid containing water and/or a fluid containing coagulant, for example, gas, mist, vapour, etc.

If NMMO is used as a direct solvent in the lyocell spinning mass, the coagulation liquid may be a mixture of demineralized water and 0% by weight to 40% by weight of NMMO, preferably 10% by weight to 30% by weight of NMMO, particularly preferably 15% by weight to 25% by weight of NMMO. A particularly reliable coagulation of the extruded filaments can thereby be achieved.

Furthermore, it is an object of the invention to improve a device for the production of spunbonded nonwoven according to the initially mentioned type in such a way that it allows

the water consumption during washing and hydroentanglement to be reduced in a structurally simple and inexpensive manner.

The invention achieves the object that is posed in that the outlet of the hydroentanglement is flow-connected to the inlet of the washing.

If the outlet of the hydroentanglement is flow-connected to the inlet of the washing, the waste water from the hydroentanglement can be reused in the washing in a structurally particularly simple manner, whereby the water consumption is minimized.

In this context, “flow-connected” is understood to mean the existence of a connection for enabling a flow of fluids between outlets and/or inlets, which, in particular, is continuous.

Thus, by means of the present invention, a device is furthermore provided which reduces the expenditure on mechanical engineering as well as plant engineering and construction during the planning, construction and operation of a plant for the production of hydroentangled, in particular cellulosic, spunbonded nonwovens.

The expenditure on equipment and thus the construction costs of the device can be reduced further if the hydroentanglement is designed as part of the washing. This may prove to be advantageous especially if the washing is a countercurrent washing with several washing stages and, at the same time, the hydroentanglement is designed as the final washing stage in the washing. In this connection, in particular the respective outlet of a washing stage or, respectively, the hydroentanglement is flow-connected to the inlet of the upstream washing stage so that fresh water is supplied only to the hydroentanglement and the waste water is discharged from the first washing stage.

A degassing device for degassing the waste water and/or a filter for removing solids from the waste water of the hydroentanglement may furthermore be provided between the washing inlet flow-connected to the outlet of the hydroentanglement or, respectively, an upstream washing stage.

The operating costs of the device according to the invention can be reduced further if the outlet of the washing is flow-connected to a water treatment system for the recovery of solvent and fresh water from the waste water of the washing. In this way, the spent wash water discharged from the outlet of the washing or, respectively, the first washing stage can be supplied back to a water treatment system, from which solvent and fresh water can, in turn, be recovered.

The advantages mentioned above are obtained especially if the water treatment system is flow-connected to the inlet of the hydroentanglement for the supply of fresh water. Thus, the fresh water recovered from the waste water of the washing can be supplied back to the hydroentanglement, whereby a water circuit is created, which allows a minimum consumption of water and thus contributes significantly to a reduction in the operating costs of the device.

Furthermore, the hydroentanglement may comprise, according to the invention, at least one high-pressure pump for demineralized water, at least one hydroentanglement nozzle bar flow-connected to the high-pressure pump, at least one suction device underneath the hydroentanglement nozzle bar, the suction device being flow-connected to the outlet, and at least one degassing device between the suction device and the outlet. In this case, the degassing device may be, for example, an air/water separator for separating the water collected in the suction device from entrained air. For example, the suction device can, in this case, be connected to a vacuum fan in order to generate the vacuum required for the suction device. The suction device may be designed, for example, as a suction pipe underneath the nozzle bar of the hydroentanglement.

Downstream of the perforated first conveying device for forming the spunbonded nonwoven, the device may furthermore comprise a second conveying device for the spunbonded nonwoven, which is provided between the nozzle bars of the hydroentanglement and the suction device. In this case, the second conveying device may, in particular, have an embossing structure with an embossing pattern, with the spunbonded nonwoven being provided with the embossing pattern during the hydroentanglement.

### BRIEF DESCRIPTION OF THE DRAWINGS

Preferred embodiment variants of the invention are described in further detail below with reference to the drawings.

FIG. 1 shows a schematic illustration of the process according to the invention or, respectively, of the device according to the invention as per a first embodiment variant,

FIG. 2 shows a detailed schematic illustration of the washing and hydroentanglement according to a second embodiment variant of the invention,

FIG. 3 shows a schematic illustration of the process according to the invention or, respectively, of the device according to the invention as per a third embodiment variant,

FIG. 4 shows a schematic illustration of the process according to the invention or, respectively, of the device according to the invention as per a fourth embodiment variant, and

FIG. 5 shows a schematic illustration of the process according to the invention or, respectively, of the device according to the invention as per a fifth embodiment variant.

### DETAILED DESCRIPTION OF THE INVENTION

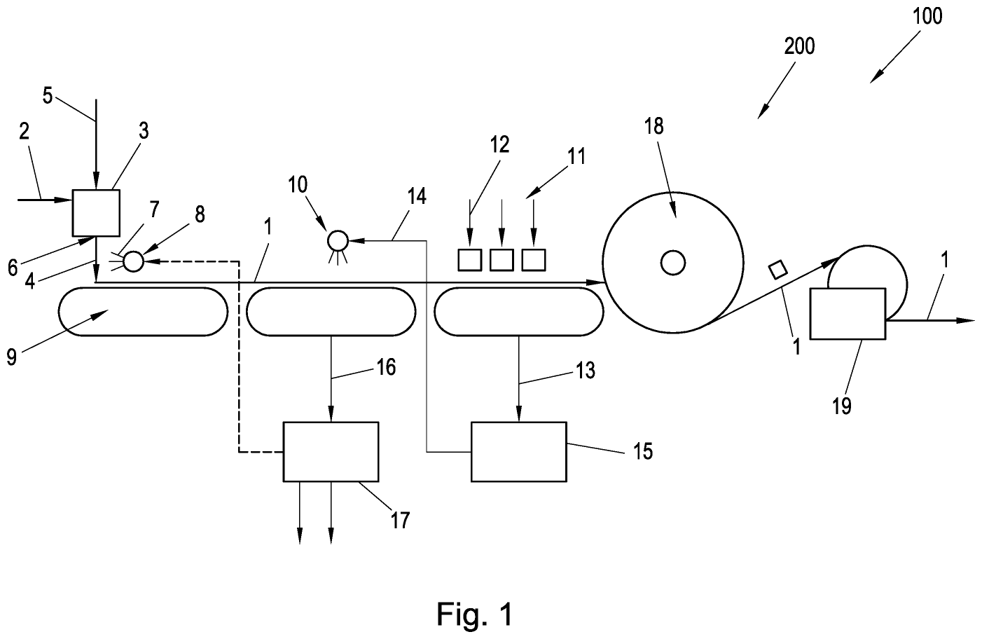

FIG. 1 shows a schematic illustration of a process 100 for the production of a spunbonded nonwoven 1 according to a first embodiment variant of the invention and a device 200 for performing the process 100. In a first process step, a spinning mass 2 is produced from a cellulosic raw material and supplied to a spinneret 3 of the device 200. In this case, the cellulosic raw material for producing the spinning mass 2, which production is not shown in further detail in the figures, can be a conventional pulp made of wood or other plant-based starting materials, which is suitable for the production of lyocell fibres. However, it is also conceivable that the cellulosic raw material consists at least partly of production waste from the production of spunbonded nonwoven or recycled textiles. In this case, the spinning mass 2 is a solution of cellulose in NMMO and water, with the cellulose content in the spinning mass ranging between 3% by weight and 17% by weight.

In a following step, the spinning mass 2 is then extruded through a plurality of nozzle holes in the spinneret 3 to form filaments 4. The extruded filaments 4 are then accelerated and drawn by a drawing air stream. For generating the drawing air stream, a drawing device 6 is provided in the spinneret 3, which device is supplied with drawing air 5 and ensures that the drawing air stream exits the spinneret 3 in order to accelerate the filaments 4 after their extrusion.

In one embodiment variant, the drawing air stream can emerge between the nozzle holes of the spinneret 3. In a further embodiment variant, the drawing air stream may alternatively emerge around the nozzle holes. However, this is not illustrated in further detail in the figures. Such spinnerets 3 comprising drawing devices 6 for generating a drawing air stream are known from the prior art (U.S. Pat. Nos. 3,825,380 A, 4,380,570 A, WO 2019/068764 A1).

Moreover, the extruded and drawn filaments 4 are additionally charged with a coagulation air stream 7, which is provided by a coagulation device 8. The coagulation air stream 7 usually comprises a coagulation liquid, for example, in the form of vapour, mist, etc. Due to the contact of the filaments 4 with the coagulation air stream 7 and the coagulation liquid contained therein, the filaments 4 are coagulated at least partly, which, in particular, reduces adhesions between the individual extruded filaments 4.

The drawn and at least partially coagulated filaments 4 are then deposited in a random orientation on the conveying device 9, forming the spunbonded nonwoven 1 there. After its formation, the spunbonded nonwoven 1 is subjected to washing 10 and hydroentanglement 11.

In doing so, the hydroentanglement 11 is provided with demineralized fresh water 12, which is sprayed onto the spunbonded nonwoven 1 under high pressure, thereby solidifying it. The waste water 13 from the hydroentanglement 11 is supplied to the washing 10 as wash water 14. Since the washing 10 is located upstream of the hydroentanglement 11, the waste water 13 from the hydroentanglement 11 is contaminated with solvent only to a minor extent and can therefore be readily used as wash water 14 for the purposes of the washing 10.

Before the waste water 13 is supplied to the washing 10 as wash water 14, the waste water 13 is guided through a degassing device 15 especially in order to remove air that has been introduced into the waste water 13.

The waste water 16 of the washing 10 is finally discharged and can be supplied to a water treatment system 17 for the recovery of purified water and, respectively, solvent. The purified water can then be supplied back to the hydroentanglement 11 as fresh water 12, which, however, is not illustrated in further detail in the figures. Recovered solvent can be used in particular for the renewed production of spinning mass 2 from a cellulosic raw material, which, similarly, is not illustrated in further detail in the figures.

In a further embodiment variant, which is only indicated in the figures, the waste water 16 of the washing can be supplied to the coagulation device 8 at least partially also as a coagulation liquid.

In a following step, the washed and hydroentangled spunbonded nonwoven 1 is then subjected to drying in a dryer 18 in order to remove the remaining moisture and to obtain a finished spunbonded nonwoven 1. Finally, the process 200 is concluded by optionally winding 19 and/or packaging the finished spunbonded nonwoven 1.

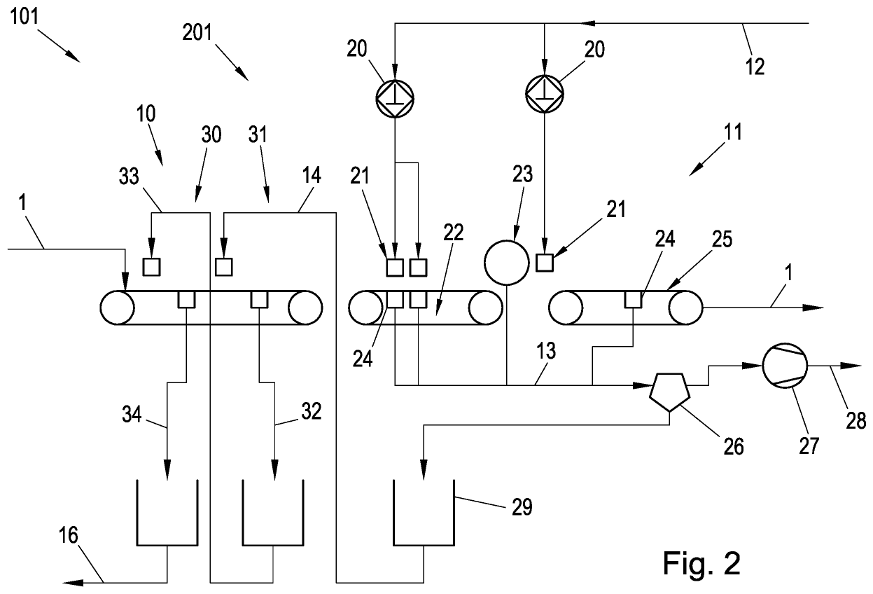

FIG. 2 shows a detailed schematic illustration of the washing 10 and the hydroentanglement 11 in a process 101 or, respectively, a device 201 according to a second embodiment variant of the invention.

During the hydroentanglement 11, demineralized fresh water 12 is supplied to high-pressure pumps 20, which are connected to the hydroentanglement bars 21 and spray the fresh water 12 under high pressure onto the spunbonded nonwoven 1 on the conveyor belt 22 or, respectively, on the conveyor drum 23, whereby it is solidified.

In doing so, the waste water 13 is removed via suction pipes 24 as a suction device through the conveyor belt 22 and through the conveyor drum 23. In addition, the spunbonded nonwoven 1 is then dewatered again on the dewatering belt 25 before it is conveyed further to the dryer 18, which has not been illustrated in further detail.

The waste water 13 from the hydroentanglement 11, which is obtained from the suction pipes 24, contains a water/air mixture and is supplied to the degassing device 26 in order to remove the air. In doing so, the exhaust air 28 is removed from the waste water 13, for example, via a vacuum pump 27, while the gas-free waste water is collected in the storage container 29.

The waste water is then supplied from the storage container 29 to the washing 10 as wash water 14. As can be seen in FIG. 2, the washing 10 is, in this case, designed as a countercurrent washing 10 with two washing stages 30, 31, the wash water 14 being supplied to the second washing stage 31, which is downstream of the first washing stage 30. The waste water 32 of the second washing stage 31 is then supplied to the first washing stage 30 as wash water 33. The waste water 34 of the first washing stage, which is enriched with solvent from the spunbonded nonwoven 1, is then discharged from the washing 10 as waste water 16 or, as illustrated in FIG. 1, is supplied to a water treatment system 17.

The demineralized fresh water 12 thus gets enriched with solvent from the spunbonded nonwoven 1 on its way through the hydroentanglement 11 and through the washing 10 and is finally supplied to the water treatment system 17 in order to recover solvent and demineralized fresh water from the waste water 16.

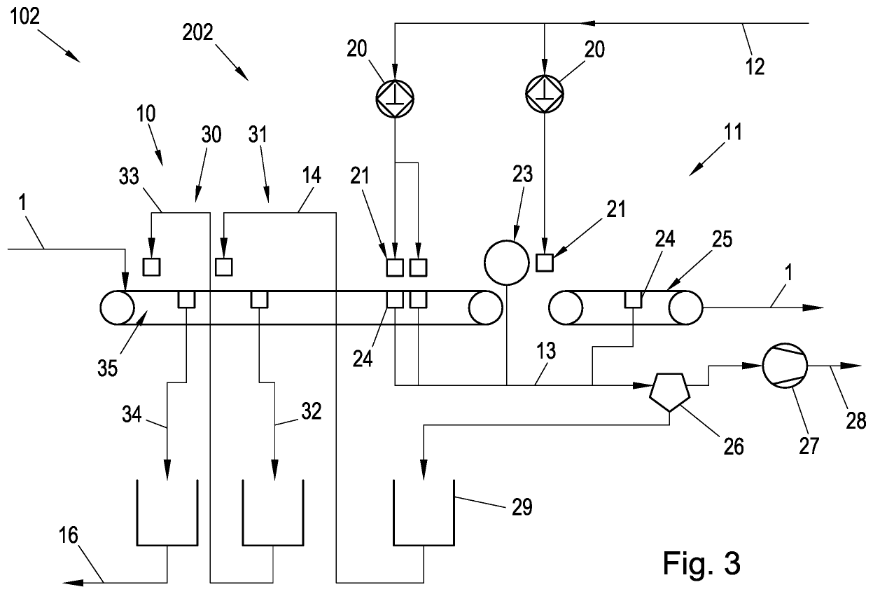

FIG. 3 shows a detailed schematic illustration of the washing 10 and the hydroentanglement 11 in a process 102 or, respectively, a device 202 according to a third embodiment variant of the invention.

The embodiment variant in FIG. 3 differs from that in FIG. 2 merely in that the spunbonded nonwoven 1 is subjected to the washing 10 and the hydroentanglement 11, in each case, on a common second conveyor belt 35. As a result, the expenditure on mechanical engineering and on equipment for the device 202 can be reduced further.

With regard to all further features of the process 102 and the device 202, reference is made to the above description of the embodiment variant according to FIG. 2.

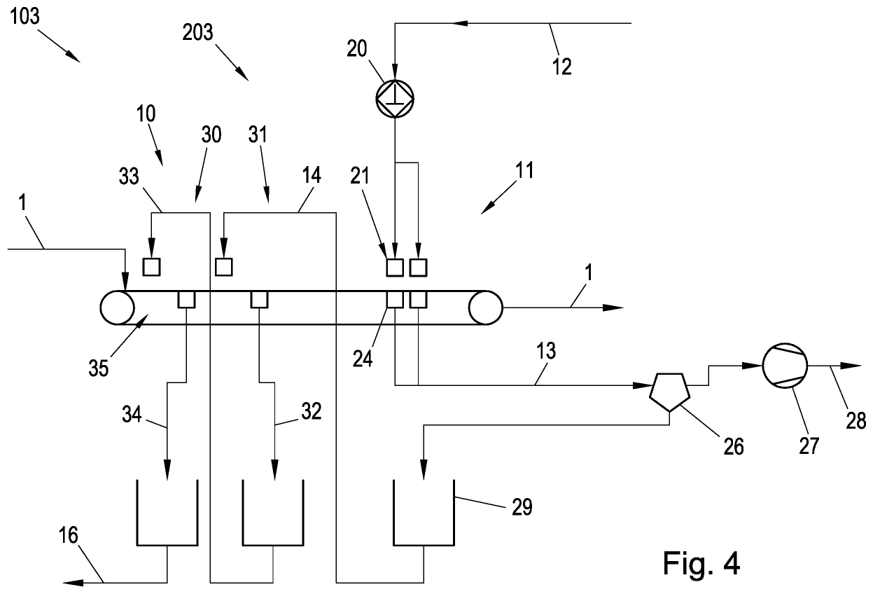

FIG. 4 shows a further detailed schematic illustration of the washing 10 and the hydroentanglement 11 in a process 103 and a device 203 according to a further embodiment variant of the invention.

As illustrated in FIG. 4, the conveyor drum 23 and the dewatering belt 25 have been omitted in the hydroentanglement 11, as compared to the variant depicted in FIG. 3. Therefore, the hydroentanglement 11 takes place exclusively on the conveyor belt 35 that is shared with the washing 10. In this case, the hydroentanglement 11 is preferably designed as the final stage of the multi-stage countercurrent washing 10, whereby the expenditure on mechanical engineering and on equipment can be reduced further. With regard to further features, reference is made to the descriptions of FIGS. 2 and 3.

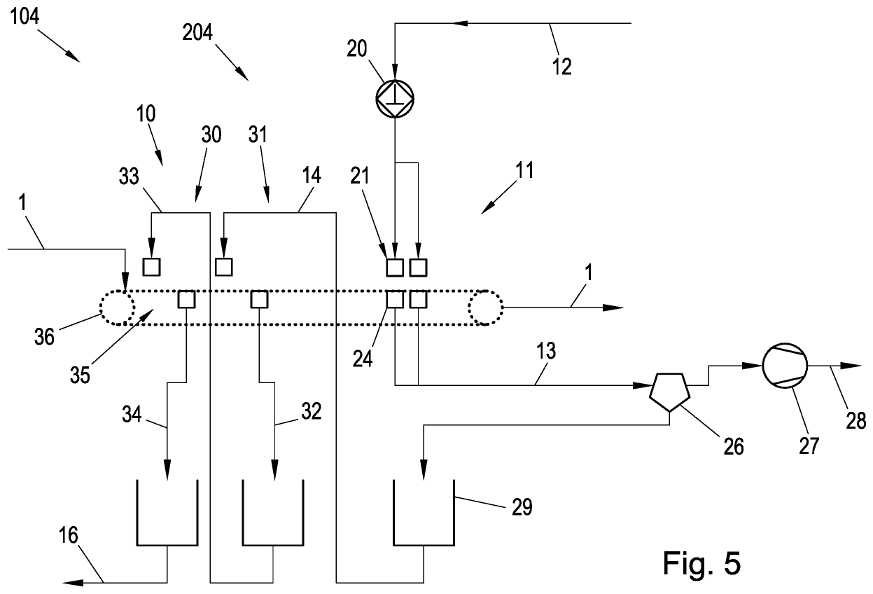

In a further preferred embodiment, which is illustrated in FIG. 5, in the process 104 according to the invention and in the device 204 according to the invention, the conveyor belt 35 exhibits a three-dimensional embossing structure 36. During the hydroentanglement 11, the embossing pattern of the embossing structure 36 is then transferred to the spunbonded nonwoven 1, which displays the embossing pattern after the hydroentanglement 11. All other features remain as they have been described in accordance with FIGS. 2, 3 and 4.

1. A process for producing a spunbonded nonwoven comprising:
extruding a solvent comprising a spinning mass through a plurality of nozzle holes of at least one spinneret to form filaments,
drawing the filaments, in each case, in an extrusion direction, wherein the filaments are deposited on a perforated conveying device to form the spunbonded nonwoven,
washing the solvent from the filaments and
subjecting the filaments to hydroentanglement wherein fresh water is supplied to the hydroentanglement and waste water from the hydroentanglement is supplied to the washing as wash water.

2. The process according to claim 1, wherein the fresh water is demineralized water.

3. The process according to claim 1, wherein the washing is a multi-stage countercurrent washing and the waste water from the hydroentanglement is passed in as countercurrent to the wash water through washing stages of the multi-stage countercurrent washing.

4. The process according to claim 3, wherein the hydroentanglement is designed as a final washing stage in the multi-stage countercurrent washing.

5. The process according to claim 1, further comprising degassing the waste water from the hydroentanglement and supplying the degassed waste water to the washing as the wash water.

6. The process according to claim 1, further comprising supplying the waste water from the washing to a water treatment system.

7. The process according to claim 6, comprising recovering the solvent from the waste water in the water treatment system.

8. The process according to claim 6, further comprising recovering purified water in the water treatment system from the waste water and supplying the purified water at least partially to the hydroentanglement as the fresh water.

9. The process according to claim 1, wherein the spunbonded nonwoven is subjected to the hydroentanglement on a second conveying device.

10. The process according to claim 9, wherein the second conveying device exhibits an embossing structure with an embossing pattern and the spunbonded nonwoven is provided with the embossing pattern by the hydroentanglement on the second conveying device.

11. The process according to claim 1, wherein the spinning mass is extruded into the filaments through the plurality of nozzle holes of more than one of the at least one spinneret arranged one behind another and the filaments are drawn, in each case, in the extrusion direction by a drawing air stream, wherein the respective filaments of the more than one spinneret are deposited on top of one another on the perforated conveying device to form a multi-layered spunbonded nonwoven.

12. The process according to claim 1, wherein the spunbonded nonwoven is a cellulosic spunbonded nonwoven, and the spinning mass is a solution of cellulose in a direct solvent, optionally a tertiary amine oxide.

13. A device for producing a spunbonded nonwoven, comprising:
at least one spinneret for extruding a spinning mass into filaments;
a drawing device for drawing the extruded filaments by means of a drawing air stream, the drawing device being allocated to the at least one spinneret;
a perforated conveying device for depositing the filaments and forming the spunbonded nonwoven;
a washing for washing the spunbonded nonwoven after formation;
a hydroentanglement downstream of the washing the hydroentanglement and the washing each has an inlet for fresh water and an outlet for waste water, and wherein the outlet of the hydroentanglement is flow-connected to the inlet of the washing.

14. The device according to claim 13, wherein the outlet of the washing is flow-connected to a water treatment system for recovering solvent and the fresh water from the waste water of the washing.

15. The device according to claim 14, wherein the water treatment system is flow-connected to the inlet of the hydroentanglement for supplying the fresh water.
